(19) United States
(12) Patent Application Publication
(10) Pub. No.: US 2004/0024734 A1
(43) Pub. Date: Feb. 5, 2004

(54) Method of performing a client investigation by means of a mobile terminal

(76) Inventor: Markku Pajusuo, Vantaa (FI)

Correspondence Address: FASTH LAW OFFICES, 629 E. BOCA RATON ROAD, PHOENIX, AZ, 85022, US

(21) Appl. No.: 10/343,282

(22) PCT Filed: Jul. 27, 2001
(86) PCT No.: PCT/FI01/00685

(30) Foreign Application Priority Data
Jul. 28, 2000 (FI) 20001723

(51) Int. Cl. G06F 7/00

(52) U.S. Cl. 707/1

(57) ABSTRACT

The object of the invention is a method to carry out an investigation by means of a mobile terminal in client spaces. In the invention, questionnaire forms are place in client spaces either in a stand or without. The questionnaire forms perform the task of giving information of the investigation for the client, present the questions of the investigation and instruct in sending the response by means of the mobile terminal. The response sent by the client is transferred via the closet base station of the selected teleoperator to the distributor of the method via a computer program to a database. The computer program performs the checking of the sending place of the response before the response is connected to be part of the investigation material. The computer program also accepts only a desired number of responses from the same mobile connection before the response is connected to be a part of investigation material. The investigation results which are updated in real-time can be followed externally independently of time and place for example in internet. To follow up the investigation results, user profiles can be created according to instructions of the sender of the method by means of which rights are created to follow investigation results according to each other. Investigation results can be received also to mobile connections. An own mobile message can be sent to clients that have responded.

### TECHNICAL FIELD

The invention is concerned with a method for performing a client investigation from different client places of a client space by means of a mobile terminal. Clients respond to presented investigation questions with a mobile terminal, which response is sent to a server of the method provider. The responses sent with the mobile terminal are converted in a form to be presented as investigation results, where after ready results can be achieved from a data base.

### BACKGROUND ART

It is known to use different mechanical distribution and collection units of table, wall or floor type, which are placed in the client spaces of companies at the service consumed by the client. From these units, the clients can take a form to be filled and return it after filling to a container. Such methods are either based on a form to be filled in by pen or on oral questions to be made at the client spaces.

A problem in known mechanical methods of collecting investigation material is that the forms to be used can, on purpose or by mistake, be wrongly filled in by the user, whereby the investigation material becomes completely or partly useless. In known methods of collecting investigation material, the same client can namely respond to same questions over and over again during the same client service even if that is not desired in view of the results of the investigation.

Those known mechanical methods of collecting investigation material, in which the clients fill in forms by pen, furthermore, require an additional step for transferring the collected investigation material to a database before the investigation results can be brought into a form for further presentation.

In those known methods of collecting investigation material, wherein the client fill questionnaires in electronic form with different electronic terminals, there is still required an additional step to transfer the stored investigation material to the databases of different terminals and convert it to results that can be presented. Also electronic methods of collecting investigation material from client spaces exist, wherein the investigation material directly goes to a database from which the investigation results can be achieved without any additional steps. All these, however, involve the problem that the questions can not directly be spread out to for example to small tables in client spaces and where the client consumes the service paid. Instead, they are placed physically in one unit only and in one place at a time in the client spaces.

Furthermore, most of the known electronic methods of collecting investigation material to be placed in client spaces can be used only by one client at a time.

From the international patent publication WO 98/09451 there is known a method to respond to short messages. An electronic questionnaire is used for wireless communication. In this method, the questions are sent as a SMS message to a selected target group, for example on the basis of its geographical position, which is defined on the basis of the area covered by a given base station. The client can then respond to the questionnaire at a desired time.

The international patent publications WO 00/41415, WO 99/04274 and WO 99/59096 are also referred to as prior art. These present methods to present a questionnaire and the responding to these. These methods are, however, not suitable for investigations made at client spaces during the service. The two last mentioned publications do not contain any possibility to answer to the investigation by a mobile terminal during such a service. In the first mentioned publication again there is not any possibility to present the investigation form for the client during the service, which is essential in investigations performed on client spaces.

The general object of the invention is to develop a method for performing a client investigation on the basis of questions to be placed at client spaces, which method better than the methods of prior art can be used as tools to improve the business.

The object of the invention is also a method to carry out a client investigation which avoids the above mentioned disadvantages.

### SUMMARY OF THE INVENTION

In the method of the invention a client investigation is performed from different client places of a client space by means of a mobile terminal. In the method investigation questions are presented, to which clients respond with the mobile terminal. The responses are sent to a server of the method provider. The responses sent with the mobile terminal are converted in a form to be presented as investigation results, where after ready results can be achieved from a database. The method is characterized in that the investigation questions are presented in investigation forms placed in different client places of client spaces, which contain a message of the possibility to take part in an investigation with a mobile terminal, investigation questions and instructions how to respond to the investigation. Each investigation form is individualised by means of an identity, which identity contains information of the place of the investigation form and differs each investigation form from each other.

In the invention quantitative and qualitative investigation material can be collected immediately during the service or after that by avoiding the above mentioned disadvantages. Still, the method enables considerable cost savings and provides a real time investigation service.

By means of the invention, it is possible to place a desired amount of fixed or mobile mechanical or electronic identified questionnaires in a stand at client spaces, which can be for example in a restaurant, a train, an amusement park etc. The questionnaires comprise instructions for responding. The client can fill in the questionnaire and return the responses to the questions of the questionnaire by means of their own mobile terminal during the service. The investigation material to be collected by the mobile terminal of the client is transferred directly to a database after converting with a computer program, and the investigation results can then be achieved without any further steps as ready presentable results.

The questionnaires can be spread to small tables, planes and walls of the client spaces directly where the clients consume the service paid.

In known electronic methods of collecting investigation material, direct investigation results can only be followed at the client space itself.

Known electronic methods of collecting investigation material from client spaces are either completely new for their first users or partially new what increases the need for guidance and increases the threshold to take part in the questionnaire.

Known methods of collecting electronic investigation material from client spaces do not directly give any information of the person taking part in the investigation if he does not by himself feed information to the actual system.

In the method of the invention, otherwise than in known methods of collecting investigation material, an interactive dialogue can be carried out on different levels with the participant after that he already has filled in and returned the questionnaire form. This takes place by sending further questions to the client directly to his mobile terminal.

In the invention, a real time connection can be achieved to the client also after that the client or the representative for the investigation itself has left the client space.

In known methods of collecting investigation material, the investigator can not get and transfer information of the investigation in real time.

By means of the invention, the feeding of investigation material to the system is carried out with the clients' own mobile terminals and so the company does not need to carry out any extensive equipment investments or other costs involved in these in order to perform the investigation. In known methods of collecting investigation material from client spaces, the costs for providing the equipment needed is in the whole paid by the investigator.

By means of the invention, the client can return and fill in his answer to the questions in the questionnaire with his mobile terminal on purpose or by mistake in a wrong form but the investigation material is included only if the material is sent in the right form, whereby useless investigation material can be completely avoided.

The invention has such properties that all clients in the company can use it simultaneously.

In the invention, even if the same client can respond to the same questions over and over again during the same client visit and after that, the responses transferred to the investigation material can be restricted so that repeated answers from the same mobile terminal stay outside the investigation material.

The use of the invention is familiar for the users because they use their own mobile terminals. This decreases the need for instructions and lowers the threshold to participate in the investigation. The responses sent by the mobile terminal can be sent to the same telephone number or network address.

By means of the invention, such information can be received from the responder which he does not need to feed to the system automatically by himself, because he uses his own mobile terminal.

Additional services can be connected to the invention, which are available for the client and investigator anytime and anywhere.

By means of the invention, the investigator can directly receive information from the investigation, results when needed in real time independently of time and place, manually as well as automatically.

For the investigator, the invention enables a possibility to present further question or questions to the clients that have responded and have an interactive dialogue with the client even if the client already has left the investigation target.

In view of the data security of the method for collecting investigation material, the invention secures the data security of the fed investigation material as the data is stored digitally to a system outside the client spaces.

The use of the invention can be administrated in different ways. If for example th investigator wishes to have results only from a given time period, the collecting of investigation material can be interrupted by the investigator without the need to move the forms physically away.

The only visible part for the client taking part in the investigation is the questionnaires. Known questionnaires placed on client spaces are always physically handled by their users, which might destroy them.

The method of the invention for collecting investigation material by means of a mobile terminal in client spaces is characterized by what is presented by the patent claims.

Such, the investigation forms to be placed in the client spaces are mechanical forms, for example written forms or electronic forms and contain a message of the possibility to take part in the investigation by means of a mobile terminal, the investigation task and instructions to respond to the investigation.

In the following, the invention is described more in detail by means of an example with reference to the enclosed drawing, which presents the method of the invention for carrying out an investigation by means of mobile terminals, for example from all restaurants of a restaurant chain simultaneously. The method both contains the collecting of the investigation material from the investigation target and a real time presentation of the investigation results. The invention is not restricted to the example or its details.

### FIGURES

FIG. 1 presents as an example a mechanical investigation form 1 which consists of a form placed in a table type stand.

FIG. 2 presents the system of the invention to carry out the client investigation.

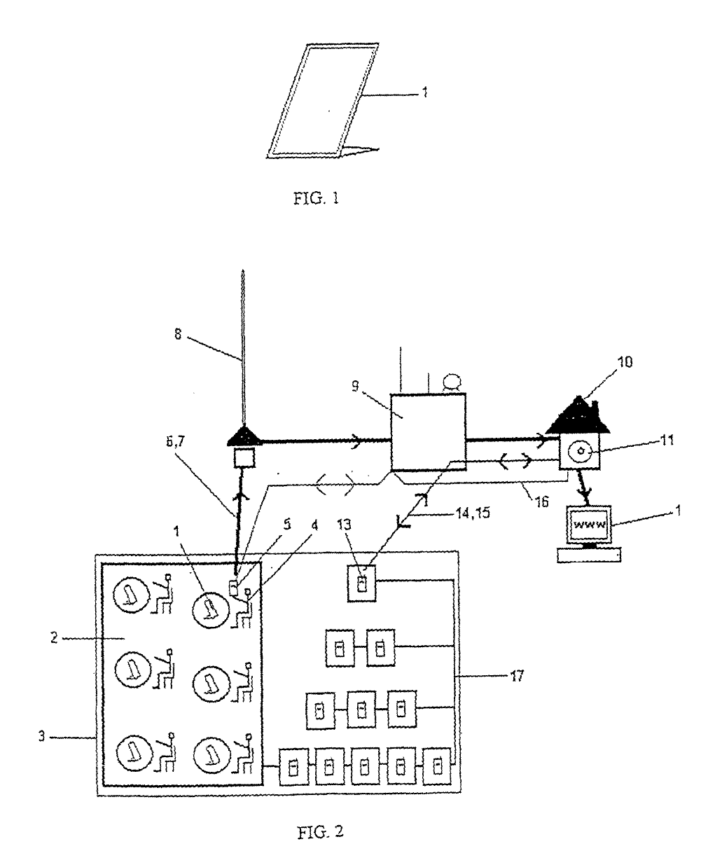

### DETAILED DESCRIPTION OF THE FIGURES

In FIG. 2, the investigation target 2 is one of many restaurants of a restaurant chain 3. The investigation target 2 is a restaurant with six tables for clients. A client 4 responds to the questions presented in the investigation form 1 with his mobile terminal 5 for example with a SMS text message 6 or e-mail 7. The response is sent to the method distributor 10 via a base station 8 and the teleoperator 9. The base station 8 is the closest base station of a teleoperator 9 mediating radio traffic. The response that has been sent to the method distributor 10 in real time via the teleoperator 9 is converted by means of a computer program 11 in a form to be presented further as investigation results. The investigation results are then transferred further to the orderer of the investigation for example to a restaurant chain 3 for example by means of a SMS message 14 or e-mail 15. The method provider can send a SMS message 16 to the mobile terminal 5 of the client 4 as a response to the client's response. In the example, there are organisation levels with different user profiles 17 belonging to the restaurant chain 3 including the target 2.

In the method, there has been placed investigation forms 1, to be answered by all the clients, in a stand on all six tables of the restaurant 2 of the restaurant chain 3, the stand being for example of plastic and the form is paper. The method is suitable to be used in all kinds of different client spaces, moving or fixed, as for example hotel rooms, boat cabins, seats in a train etc. The investigation forms can also be of wall type or they can be placed on for example the back side of a seat without a separate stand. Generally, the investigation form can be either mechanical or electronic.

The investigation form 1 brings to the client 4 coming to a table of the restaurant 2 unidirectionally a message of the possibility to take part in the investigation with a mobile phone, the questions themselves and the instructions for how the client can respond to the questions presented by using his own mobile phone 5. The client 4 does not need to bring the questions of the investigation separately to her mobile phone 5 to answer them. It is instead possible to take part in the investigation and respond to the questions directly by following the instructions.

The idea is that, as the investigation form 1 is placed on a table in a restaurant 2 and it is not taken away by anyone, the client 4 likely responds to the questions presented in the investigation form 1 at the investigation target him being at this place during the service.

Each investigation form 1 is individualised according to the restaurant 2 to its place by means of an identity, whereby the investigation forms 1 of a given client space differ from each other at least with respect to the identity in them.

The questions presented in the investigation form 1 can contain multiple selection questions, which are answered to with a given evaluation scale whereby quantitative investigation material can be received. The questions presented in the investigation form 1 can also contain open questions whereby qualitative investigation material is received. The identity that identifies each investigation form 1 is connected to the response.

After having decided to take part in the investigation, the client 4 of the restaurant 2 responds to the questions in the investigation form 1 with his mobile terminal 5 by following the instructions in the investigation form 1, for example as a SMS text message 6 or e-mail 7 to the telephone number or net address of the teleoperator 9 given in the investigation form 1. All clients of the restaurant 2 can respond simultaneously to the investigation form 1. When the scale to evaluate the issues of the questions presented in the investigation form 1 is for example 1-5 (and the number of questions are e.g. five), the response sent by the client 4 of the restaurant with his mobile phone 5 could for example be in the form IDENTITY 12345 RESPONSE. In the response sent, the identity identifies the investigation form 1 to which the client has responded, whereby it is known from which restaurant table it has been sent. By means of the identity, responses (even if they would be sent from different places) can be sent to the same telephone number or net address. According to the actual evaluation scale, the numbers identify the opinions of the responder for answering the questions presented in the investigation form 1, for example with some number from one to five. The free response that can be voluntary to the responder, in addition to the evaluation according to the evaluation scale, is in the response given by the client with his own words. Thus, by means of the invention it is possible to collect both quantitative and qualitative investigation material.

The response sent by the client 4 with his mobile phone 5 is sent to the closest base station 8 and further via the teleoperator 9 to the method provider. The teleoperator 9 itself can also be the provider of the method. The response is stored in a database maintained by a computer program 11, only in a defined form when it has been sent by the client in a form that always is ready in a defined form (according to the instructions) and known by the computer program 11 in the database. From the database it can directly be presented in form of investigation results both in numbers and graphically. Responses that have been sent in a wrong form by the client, on purpose or by mistake, will not be included in the investigation material to be presented because such a response is not in the defined form, for example for the part of the identity and/or scale alternatives.

In the method, the computer program 11 can also confirm, by means of a navigation S function included in that, from where the response has been sent from available base station information. In the computer program 11, there can be fed in advance possible base station information that corresponds to a given restaurant 2 (actual investigation target) and that information has to correspond to the message sent or the response is not included in the investigation material to be presented. With this, it is usually guaranteed that no wrong responses (sent from outsiders) are included in the investigation results if the data of the investigation form 1 would have been brought outside the investigation target and the answer would come from a wrong place.

In the method, the computer program 11 to be used can also restrict the transferring of responses sent from the same mobile connection further to the investigation material for example by accepting only one response per day from the same mobile connection even if the client would respond to the same investigation several times a day from the same connection.

By means of the method, the orderer 3 gets a completely externalised investigation service wherein he does not need to be physically in the investigation target to be able to follow the investigation results in real time.

According to the method, the orderer of the investigation, for example a restaurant chain 3, can follow the development of the investigation results in real through internet 12 per restaurant and if desired by means of the identity in the investigation form 1 also per table. The orderer of the method can also have several different investigation targets simultaneously, as for example the different restaurants of a restaurant chain 3. Own user profiles 17 can be defined for the different users of the investigation results achieved with the method of the invention for the following of the investigation results, which profiles define the rights of the different users to get investigation data at different levels from internet 12. For example the director of a restaurant chain could have the possibility to follow the investigation results from all different result units, local managers could have the possibility to follow the investigation results only from their own result units, the manager of a unit could have the possibility to follow investigation results only from that unit and inside a unit for example a bartender could have the possibility to follow only the investigation results collected from the restaurant bar and not from the whole restaurant etc. Via the created user profiles 17, the users of the investigation data in the restaurant chain 3 can administrate the form of data presented for them, communicate with each other and order additional services to the method in internet 12.

By means of the method, data can be achieved from investigation results of for example the restaurant 2 also to the mobile terminal 13 of the representative or representatives of the restaurant chain 3 automatically by given intervals or by separately ordering the results from the method provider 10. The method also makes it possible to give different messages to the representative of the restaurant chain 3 of an alarming situation in the service chain, for example if a bad evaluation number is given by a client 4 in the restaurant, whereby the information is immediately transferred to the desired mobile terminal 14 for example in form of a SMS text message 14 or email 15, whereby the director of the restaurant 2 gets the information of what has happened to his mobile terminal 13 and can do the necessary operations before the client leaves the restaurant 2.

For example a restaurant chain 3 can, by means of the method, send his own mobile message 16 to the mobile terminal 5 of the client 4 that has responded either immediately after the response sent by the client 4 or later according to sender data of the client. The computer program 11 can be activated to send a mobile message 16 either automatically or manually, which can be an additional question or questions. The orderer of the method can thus have an interactive dialogue with the client that already has responded to the investigation independently of if he already has left the investigation target.

The method can be switched off or back on by means of the computer program 11 of the distributor 10 any time without the need to remove the forms, whereby the investigation material to be collected with the method also can be achieved in parts of given period of time.

It is clear for one skilled in the art that other solutions than those described in the examples can be performed and they can vary in the scope of the following patent claims. The different stands to be used for the investigation forms can be manufactured from for example wood, metal, cardboard, laminate, glass or other materials.

The drawings and the detailed description in connection with those is only meant to illustrate the invention. The details of the invention, as for example the number of the investigation forms to be used, the defined form for the responses and the presentation of the investigation results and the ways of transferring can vary in the scope of the patent claims.

1. Method for performing a client investigation from different client places of a client space (2) by means of a mobile terminal (5), in which method
investigation questions are presented,
clients (4) respond to the investigation questions with the mobile terminal (5), which responses are sent to a server of the method provider,
the responses sent with the mobile terminal (5) are converted in a form to be presented as investigation results, where after
ready results can be achieved from a data base,
characterized in that
the investigation questions are presented in investigation forms (1) placed at different client places of client spaces (2), which contain a message of the possibility to take part in an investigation with a mobile terminal, investigation questions and instructions how to respond to the investigation,
each investigation form (1) being individualised by means of an identity, which identity contains information of the place of the investigation form and differs each investigation form from each other.

2. Method of claim 1, characterized in that the investigation response sent with the mobile terminal (5) is in a defined form according to the instructions.

3. Method of claim 2, characterized in that the response sent in the defined form is understood by a computer program (11) which converts the response to presentable investigation results.

4. Method of claim 1, characterized in that the message sent by the mobile terminal (5) is performed as a SMS text message (14) or e-mail (15).

5. Method of claim 1, characterized in that the investigation responses can be followed in real time, for example through internet.

6. Method of claim 1, characterized in that the investigation results can directly be presented from the database in the presented form with numbers or graphically.

7. Method of claim 1, characterized in that the investigation forms (1) to be placed in client spaces (2) are mechanical forms, for example of paper.

8. Method of claim 1, characterized in that the investigation forms (1) to be placed in client spaces (2) are electronic forms.

9. Method of claim 1, characterized in that the response sent by the mobile terminal (5) can be sent to the same telephone number or net address.

10. Method of claim 1, characterized in that the response sent by the client (4) with the mobile terminal (5) can be localised by means of a computer program (11) from base station data before they are stored as investigation results.

11. Method of claim 1, characterized in that the responses sent from the same mobile terminal can be censured by means of a computer program (11) before they are stored as the investigation results.

12. Method of claim 1, characterized in that both quantitative and qualitative investigation material can be collected from an investigation target (2).

13. Method of claim 1, characterized in that the response in a defined form sent by the mobile terminal (5) by the client (4) can be converted to investigation results through the computer program (11), the response containing an identity in the investigation form and optionally numbers given according to an actual evaluation scale and/or a free written response.

14. Method of claim 1, characterized in that different user profiles (17) for the follow-up of the investigation results can be defined, which define the rights of different users of investigation data to get investigation data on different levels of its organisation (3).

15. Method of claim 1, characterized in that through created user profiles (17), the users of the investigation data can administrate the forms presented as investigation results, communicate with each other and order additional services to the method.

16. Method of claim 1, characterized in that information can be sent from the investigation results also to desired mobile terminals (13) automatically with given intervals, in different alarming situations or by separately ordering them.

17. Method of claim 1, characterized in that an own mobile message (16) can be sent automatically for example by means of a computer program (11) or manually to the mobile terminal (5) of the client (4) that has responded either immediately after that the response of the client has arrived or later according to user data of the mobile terminal of the client.

18. Method of claim 1, characterized in that the method can be switched off and back on again anytime without removing there between the investigation form from the places of a client space (2), whereby the investigation material to be collected with the method also can be achieved in parts or from given time periods.

19. Method of claim 19, characterized in that the own mobile message (16) sent to the responder forms a tool for an interactive dialogue between the method provider and the client (4) depending on the given response, automatically or manually, by presenting additional questions back to the responder, whereby the client (4) always can give a new response with his mobile terminal (5).
